(19) United States
(12) Patent Application Publication
(10) Pub. No.: US 2002/0033142 A1
(43) Pub. Date: Mar. 21, 2002

(54) Machine for preparing and distributing cattle feed

(75) Inventors: Jean-Paul Martin, Le Fenouiller (FR); Anthony Drouet, Saint Sulpice Le Verdon (FR); Robert Allain, La Rabateliere (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KUHN-AUDUREAU S.A., La Copechagniere (FR)

(21) Appl. No.: 09/951,511

(22) Filed: Sep. 14, 2001

(30) Foreign Application Priority Data
Sep. 15, 2000 (FR) 00 11910

(51) Int. Cl. A01K 61/02

(52) U.S. Cl. 119/57.1

(57) ABSTRACT

The present invention relates to a machine for preparing and distributing cattle feed, including a chassis carrying a tank with side walls, at least one of which has a flap for distributing the feed, said tank having shredding and mixing means consisting of at least one substantially horizontal screw.

It is noteworthy in that the rotational speed of the screw can be altered so that it rotates at a different speed when distributing than when shredding or mixing feed.

### BACKGROUND OF THE INVENTION

1. Field of the Invention

The present invention relates to a machine for preparing and distributing cattle feed including, in particular, a chassis, a tank which is mounted on said chassis and which is formed of a floor, two side walls, a front wall and a rear wall defining a volume that can be filled with feed, a flap for distribution on at least one side wall, shredding and mixing means which are located in the bottom of the tank, which means consist of at least one substantially horizontal screw which is driven in rotation and which has threads or blades which move the feed along inside the tank with a view to homogeneously mixing it or delivering it for distribution when a flap is open.

2. Discussion of the Background

Machines of this kind generally include one or two screws which rotate at the same speed for mixing feed and for distribution. This speed is relatively slow so as to allow the screws to get a firm grasp of the feed. The feed may consist of hay in loose or bale format, blocks of silage and other additional products which may be introduced into the tank from the top. The screws have therefore to shred these products and turn them around in the tank in order to obtain a uniform structure and to homogenize the mix.

During distribution, the screws drive the feed to the outside of the tank. The delivery rate obtained is relatively low because of the low rotational speed of the screws. The distribution operation thus takes a great deal of time. In addition, the feed may become destructured in the tank by the constant stirring effected by the screws.

### SUMMARY OF THE INVENTION

It is an object of the present invention to overcome the aforementioned drawbacks of the known machines. The invention has in particular to make it possible to accelerate the distribution of the fodder after it has been shredded and mixed.

To this end, an important feature of the invention lies in the fact that the rotational speed of the screw or screws can be altered so that it rotates at a greater speed during distribution than during shredding or mixing of the feed.

The rotational speed of the screw which effects unloading can thus be increased in such a way as to accelerate the delivery of the feed from the tank. The duration of the distribution operation is thus reduced, which allows the operator to save time and limit the stirring of the feed when the desired structure has been achieved.

According to the invention, the machine may have a screw rotationally driven by a hydraulic motor powered from a variable-delivery pump making it possible to alter the rotational speed.

According to the invention, the machine may also include two screws placed side by side and driven in rotation by hydraulic motors powered from a pump via a hydraulic circuit including an adjustable flow divider. The latter includes two valves making it possible to vary the splitting ratio of the flow divider. This may vary from 50% of the total flow to each motor during mixing to, for example, 80% of the total flow on the unloading side and 20% on the other side during distribution. The two valves may advantageously be controlled by the opening and closure of the flaps. Thus, when one of the flaps is open, the valves of the flow divider cause an increase in the rotational speed of the screw which is located on the same side as said open flap and a reduction in the rotational speed of the other screw.

According to the invention, the machine may also have one or two screws rotationally driven mechanically by means of a box containing gears that can be shifted or interchanged with a view to modifying the rotational speed.

### BRIEF DESCRIPTION OF THE DRAWINGS

Other features and advantages of the invention will become apparent from the description hereinafter of nonlimiting exemplary embodiments of the invention, with reference to the attached drawings in which:

FIG. 1 depicts a longitudinal section through a machine according to the invention;

FIG. 2 depicts a top view of this machine;

FIG. 3 depicts a diagram of the hydraulic driving means of the machine during mixing;

FIG. 4 depicts a diagram of the hydraulic driving means of the machine during distribution.

### DESCRIPTION OF THE PREFERRED EMBODIMENTS

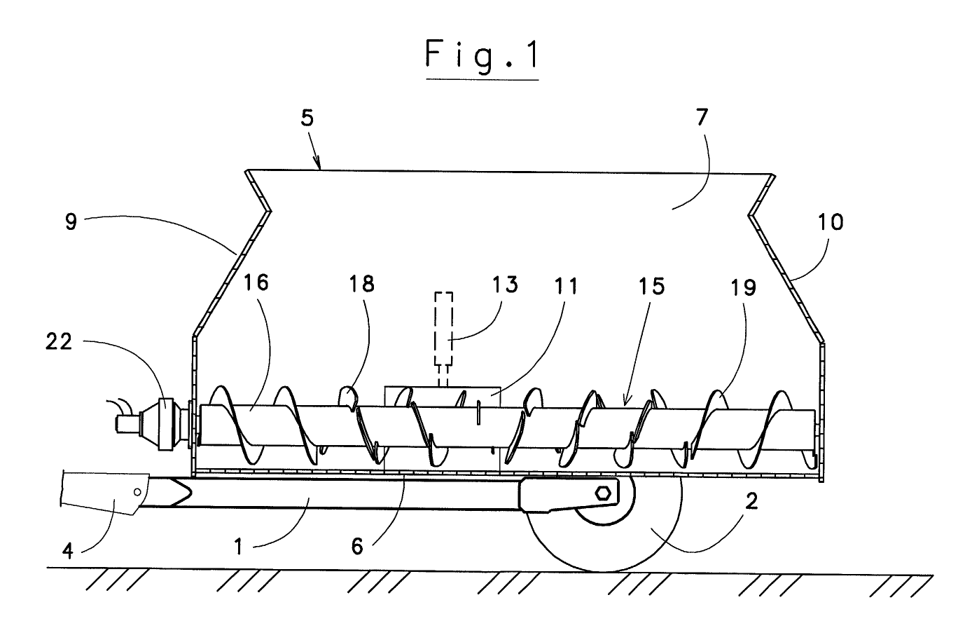

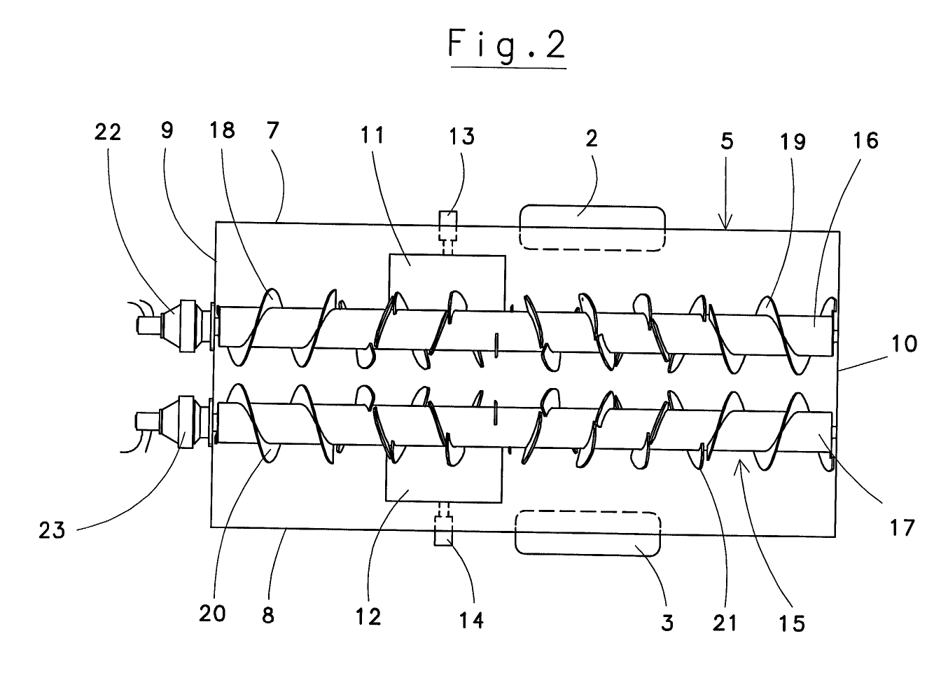

As depicted in FIGS. 1 and 2, the machine according to the invention includes a chassis 1 fitted with wheels 2 and 3 and with a draw bar 4 for attaching it to a tractor, not depicted. The machine according to the invention could also be self propelled. Mounted on said chassis 1 is a tank 5 formed of a floor 6, two side walls 7 and 8, a front wall 9 and a rear wall 10 defining a volume which can be filled with cattle feed. Each side wall 7, 8 has a flap 11, 12 in its lower part for delivering feed. The opening and closure of each flap 11, 12 can be controlled by a hydraulic ram 13, 14.

Housed in the bottom of the tank 5 are means 15 for shredding and mixing the feed. These means consist of two substantially horizontal screws 16 and 17. These screws 16 and 17 are mounted in bearings in the front and rear walls 9 and 10 so that they can turn. Each screw 16 and 17 has two threads 18 and 19, 20 and 21 of opposite winding directions, so as to move the feed along from their front and rear ends toward the middle of the tank 5. These threads 18 to 21 may be replaced by blades oriented in the same way. Each screw 16 or 17 may just as easily have just one thread. These threads 18 to 21 are advantageously equipped at their periphery with knives or similar components which cut up the feed. The floor 6 and/or the side walls 7 and 8 of the tank 5 can carry counter knives which encourage said cutting.

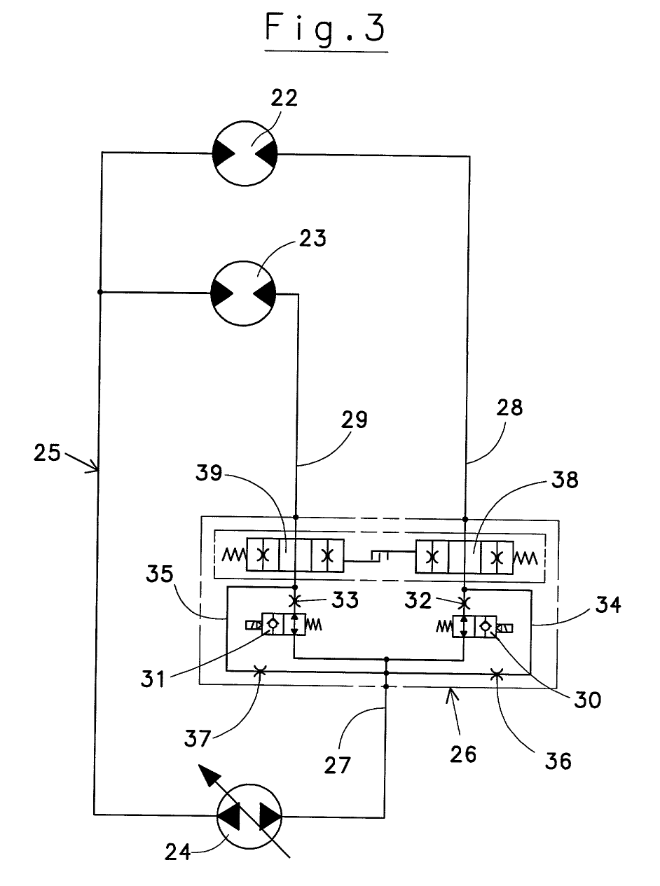

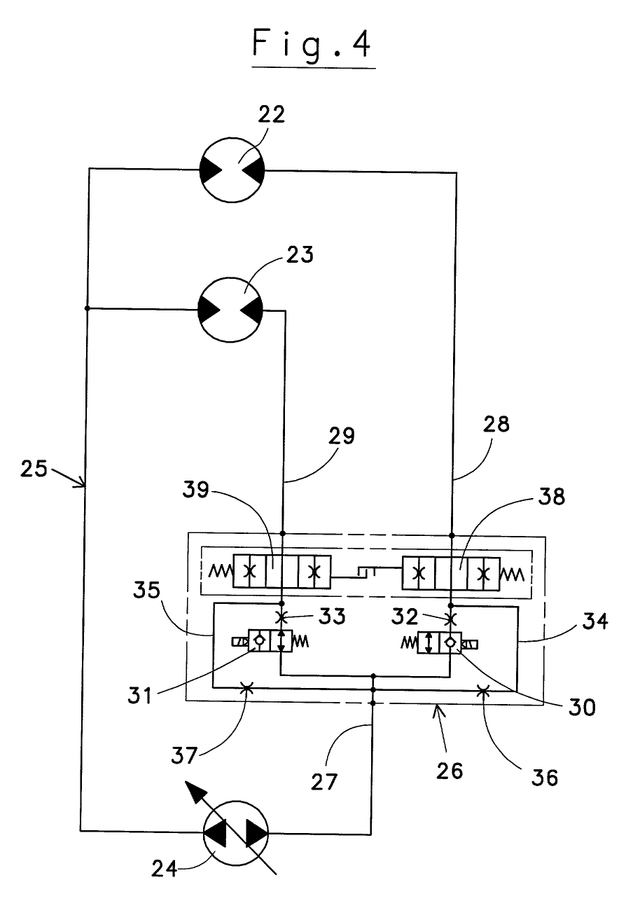

The two screws 16 and 17 can be rotationally driven at speeds that can be altered according to the operations. This drive is provided by means of hydraulic motors 22 and 23 situated on the front wall 9. As is apparent from FIGS. 3 and 4, these motors 22 and 23 are powered from a pump 24 via a hydraulic circuit 25 including an adjustable flow divider 26. The latter has an inlet duct 27 which splits into two ducts 28 and 29 each leading to one of the hydraulic motors 22 and 23. Provided on each of these ducts 28 and 29 is an adjustable valve 30 and 31 with an open position and a closed position. Control of these valves 30 and 31, which may be electrical, is advantageously twinned with the control of the distribution flaps 11 and 12. Also provided near these valves 30 and 31 are flow regulators 32 and 33. Two other ducts 34 and 35, each having a flow regulator 36 and 37 directly connect the inlet duct 27 to the two ducts 28 and 29 bypassing the valves 30 and 31. Finally, a pressure equilibrium balance 38, 39 is provided on these ducts 28 and 29 which lead to the hydraulic motors 22 and 23.

When the feed is being blended and mixed in a tank 5, the two hydraulic motors 22 and 23 are driven at substantially equal nominal rotational speeds. For this work, the distribution flaps 11 and 12 are closed and the valves 30 and 31 of the flow divider 26 are in the open position (FIG. 3) so that about 50% of the total flow passes through each of the ducts 28 and 29. Substantially identical quantities of oil therefore reach the motors 22 and 23, passing both through the valves 30 and 31 and the bypass ducts 34 and 35.

To distribute feed, one of the flaps 11 and 12 in the side walls 7 and 8 is opened to allow the delivery of feed, for example, into a trough. This opening then commands the closure of the valve 30 or 31 of the duct 28 or 29 which leads to the drive motor 22 or 23 of the screw 16 or 17 which is located on the same side as the side wall 7 or 8 that has the closed flap 11 or 12. A greater quantity of oil then passes through the duct 28 or 29 with the open valve 30 or 31 (see FIG. 4). The split ratio in which the flow of oil is split may, for example, be such that the flow passing through the duct 28 or 29 with the open valve 30 or 31 rises to 80% of the total flow and that the flow passing through the duct 28 or 29 with the closed valve 30 or 31 drops to 20% of the total flow. This arrangement gives rise to an approximately 60% increase in the rotational speed of the motor 22 or 23 of the screw 16 or 17 located close to the open flap 11 or 12 and an approximately 60% reduction in the rotational speed of the motor of the other screw.

The screw 16 or 17 which is located on the same side as the side wall 7 or 8 where the flap 11 or 12 is open then rotates more quickly and accelerates the delivery of the feed from the tank 5. It thus allows swifter distribution. Conversely, the second screw 16 or 17 slows the stirring of the feed, which maintains its structure.

If the machine has just one mixing and distribution screw in the bottom of the tank 5, the rotational speed thereof can be altered using a variable-delivery pump 24. It is thus possible to increase the rotational speed of the screw for distribution and to decrease it for blending and mixing feed by increasing or decreasing the delivery of the pump 24.

If the two screws 16 and 17 are mechanically driven, they are actuated by means of a box containing gears which can be shifted or interchanged. The rotational speed of the screws 16 or 17 can thus be increased or decreased for distributing or mixing feed, by meshing gears of different diameters.

Likewise, in the case of a machine with just one mechanically driven screw in the bottom of the tank 5, its speed can be increased or decreased by shifting or changing drive gears.

It is quite obvious that the invention is not restricted to the embodiments described hereinabove. Modifications remain possible, particularly as regards the construction or number of the various elements or by substituting technical equivalents without in any way departing from the field of protection.

What is claimed as new and desired to be secured by Letters Patent of the United States is:

1. Machine for preparing and distributing cattle feed including, in particular, a chassis, a tank which is mounted on said chassis and which is formed of a floor, two side walls, a front wall and a rear wall defining a volume that can be filled with feed, a flap for distribution on at least one side wall, shredding and mixing means which are located in the bottom of the tank, which means consist of at least one substantially horizontal screw which is driven in rotation and which has threads or blades which move the feed along inside the tank with a view to homogeneously mixing it or delivering it for distribution when a flap is open, wherein the rotational speed of the screw can be altered so that it rotates at a greater speed during distribution than during shredding or mixing of the feed.

2. Machine as claimed in claim 1, wherein the screw is driven in rotation by a hydraulic motor powered by a variable-delivery pump.

3. Machine as claimed in claim 1 and which includes two screws placed side by side and driven in rotation by hydraulic motors powered from a pump via a hydraulic circuit including an adjustable flow divider.

4. Machine as claimed in claim 3, wherein the flow divider has two valves making it possible to vary the rotational speed of the two hydraulic motors which drive the rotation of the screws.

5. Machine as claimed in claim 3, wherein the flow divider has a pressure equilibrium balance.

6. Machine as claimed in claim 4, wherein the valves are controlled by the opening and closure of the flaps.

7. Machine as claimed in claim 6, wherein the valves of the flow divider provide rotational speeds of the two screws which are substantially equal when the two flaps are closed.

8. Machine as claimed in claim 6, wherein when one of the flaps is open, the valves of the flow divider cause an increase in the rotational speed of the screw which is located on the same side as said open flap and a reduction in the rotational speed of the other screw.

9. Machine as claimed in claim 1, wherein the screw is rotationally driven mechanically by means of a box containing gears which can be shifted or interchanged with a view to altering the rotational speed.

10. Machine as claimed in claim 1, and which includes two screws placed side by side and rotationally driven mechanically by means of a box containing gears that can be shifted or interchanged with a view to altering the rotational speed of one of the screws with respect to the other.
